(19) United States
(12) Patent Application Publication
(10) Pub. No.: US 2016/0258310 A1
(43) Pub. Date: Sep. 8, 2016

(54) SEAL ARRANGEMENT

(71) Applicant: ROLLS-ROYCE PLC, London (GB)

(72) Inventors: Lynne Helen TURNER, Bristol (GB); Alan Robert MAGUIRE, Derby (GB); Sean Alan WALTERS, Bristol (GB); Matthew Kieran DUNK, Hawkesbury Upton (GB)

(73) Assignee: ROLLS-ROYCE PLC, London (GB)

(21) Appl. No.: 15/047,194

(22) Filed: Feb. 18, 2016

(30) Foreign Application Priority Data
Mar. 2, 2015 (GB) 1503480.4

(51) Int. Cl. F01D 11/02; F16J 15/447

(52) U.S. Cl. CPC F01D 11/02; F16J 15/447; F05D 2240/55; F05D 2220/32

(57) ABSTRACT

A turbine secondary air system seal arrangement (62). The arrangement comprises a first seal land (70) facing radially inwardly; a second seal land (80) facing radially outwardly; and first labyrinth seal teeth (76) directed radially outwardly to seal against the first seal land (70). Also second labyrinth seal teeth (78) directed radially inwardly to seal against the second seal land (80). The first seal land (70) is configured to move radially relative to the second seal land (80) or the first seal teeth (76) are configured to move radially relatively to the second seal teeth (78) to accommodate differential movement of the lands (70, 80) and teeth (76, 78) during use of the seal arrangement (62).

The present invention relates to a seal arrangement, particularly a double-sided seal arrangement. Such an arrangement may be a labyrinth seal arrangement. It may be used in a gas turbine engine, as a turbine secondary air system seal or otherwise.

A turbine secondary air system seal is positioned in a gas turbine engine between a stationary stage, such as a nozzle guide vane stage, and a rotating turbine. In particular it is positioned in the cavity beside the disc of the turbine stage, to which the turbine blades are mounted. A static part of the seal is mounted to the nozzle guide vane and includes two axially extending lands that are radially spaced apart. A rotating part of the seal is mounted to the turbine disc and extends axially forward between the static lands. The rotating part of the seal is configured to have fins extending radially inwards and outwards to seal against the lands as a pair of labyrinth seals.

The radially inner fins and land predominantly maintain the pressure in the cavity, particularly during deceleration of the gas turbine engine. The radially outer fins and land predominantly maintain the running clearance to maintain the sealing at the turbine rim.

One problem with the known turbine secondary air system seal is that during transient engine conditions, particularly rapid transients, the static and rotating parts of the seal move and expand or contract at different rates. This is because they are formed of different materials having different thermal growth characteristics, are subject to different pressure and centrifugal loads, and are mounted to different components which also move and expand or contract differently. Thus during transient engine conditions the fins and lands of one of the radially inner or radially outer seals may become excessively radially spaced and therefore the sealing effectiveness is reduced leading to engine performance loss. Simultaneously, the fins and lands of the other of the radially inner or radially outer seals may become too close radially and therefore contact. The resultant heat and friction between the components or erosion of one of the components leads to damage and/or component failure.

A way to counteract the problem of friction damage is to increase the radial design clearance between the fins and lands for cold conditions in order to avoid wear during transient conditions. However, this may result in poorer sealing at all engine running conditions.

The present invention provides a sealing arrangement that seeks to address the aforementioned problems.

Accordingly the present invention provides a seal arrangement comprising:

a first seal surface facing a first direction;

a second seal surface facing a second direction, the second direction opposed to the first direction; the first and second seal surfaces configured to form a seal together;

a third seal surface facing the first direction;

a fourth seal surface facing the second direction; the third and fourth seal surfaces configured to form a seal together;

wherein the first and fourth seal surfaces are configured to move relative to each other to accommodate differential movement of the seal surfaces during use of the seal arrangement.

The first and fourth seal surfaces may be mounted to a first component. The second and third seal surfaces may be mounted to a second component.

Advantageously the seal arrangement forms a labyrinth seal which can accommodate differential movement in the sealing direction of components to be sealed. Such differential movement may be caused by thermal, pressure or mechanical loading on the components and may be exacerbated by the components being formed of different materials.

The seal arrangement may be a labyrinth seal arrangement. The first and fourth seal surfaces may comprise seal lands; and the second and third seal surfaces may comprise fins or teeth. The first and fourth seal surfaces may comprise fins or teeth; and the second and third seal surfaces may comprise seal lands.

The relative movement may be substantially perpendicular to the seal surfaces. Advantageously the sealing is thus maintained across the whole of each sealing surface pair during relative movement.

The second and third seal surfaces may be supported by a common mount.

One or more of the seal surfaces may comprise a stepped profile relative to the first and second directions. Thus in cross-section one or more seal surface may be stepped such that each step surface is perpendicular to the first and second directions and there are ‘risers’ between the step surfaces. One or more of the seal surfaces may comprise an angled profile relative to the first and second directions. Thus in cross-section one or more seal surface may be angled such that the angle between the seal surface and the first and second directions is not 90°. For example the second and third seal surfaces may each be angled so that their ends away from the component to which they are mounted are closer together than at the ends where they are mounted. Thus they form a tapered arrangement.

The differential movement may comprise any one or more of: translation; rotation; thermal growth; centrifugal growth. The movement may be caused by one or more of: rotation of one or more components; heating through use or external application of heat; mechanical loading of one or more components; pressure loading of one or more components.

The first seal surface may be mounted to the fourth seal surface. Advantageously the first seal surface may experience some movement as a result of movement of the fourth seal surface and can also move relative to the fourth seal surface. Thus the relative movement of the first and fourth seal surfaces offers finer adjustment whilst the common movement of the first and fourth seal surfaces offers coarser adjustment of the movement.

The first seal surface may be mounted to the fourth seal surface by a pin in a slot. Advantageously this is mechanically simple. The first seal surface may be mounted to the fourth seal surface by a sprung coupling. Advantageously this offers damping or resistance to the relative movement.

The first and fourth seal surfaces may be mounted to different components. Advantageously this is mechanically simple.

The first seal surface may comprise a different material to the fourth seal surface. Advantageously the materials may have different thermal expansion coefficients and/or thermal diffusivity. Therefore the seal surfaces may expand or contract at different rates in response to thermal loading.

The arrangement may be annular. The relative movement may be radial.

The first and fourth seal surfaces may be static; and the second and third seal surfaces may rotate. Alternatively the first and fourth seal surfaces may rotate; and the second and third seal surfaces may be static. Alternatively the first and fourth seal surfaces may rotate; and the second and third seal surfaces may also rotate.

A rotational arrangement comprising a rotating stage, a static stage and a seal arrangement as described arranged between the rotating stage and the static stage.

A gas turbine engine comprising a seal arrangement as described. A gas turbine engine comprising a rotational arrangement as described.

A turbine secondary air system seal arrangement comprising:

a first seal land facing radially inwardly;

a second seal land facing radially outwardly;

first labyrinth seal teeth directed radially outwardly to seal against the first seal land;

second labyrinth seal teeth directed radially inwardly to seal against the second seal land;

wherein
i) the first seal land is configured to move radially relative to the second seal land or
ii) the first seal teeth are configured to move radially relatively to the second seal teeth

to accommodate differential movement of the lands and teeth during use of the seal arrangement.

Advantageously the turbine secondary air system seal arrangement provides a better seal than known arrangements, particularly during transient conditions where relative radial movement is pronounced.

A gas turbine engine comprising a turbine secondary air system seal arrangement as described.

Any combination of the optional features is encompassed within the scope of the invention except where mutually exclusive.

The present invention will be more fully described by way of example with reference to the accompanying drawings, in which:

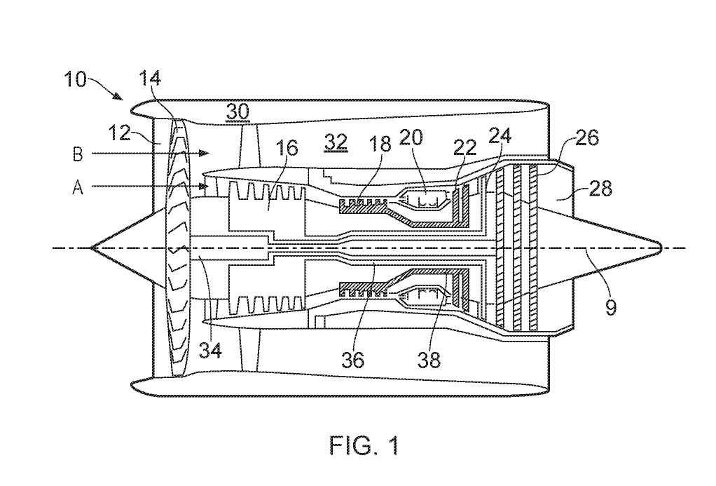

FIG. 1 is a sectional side view of a gas turbine engine.

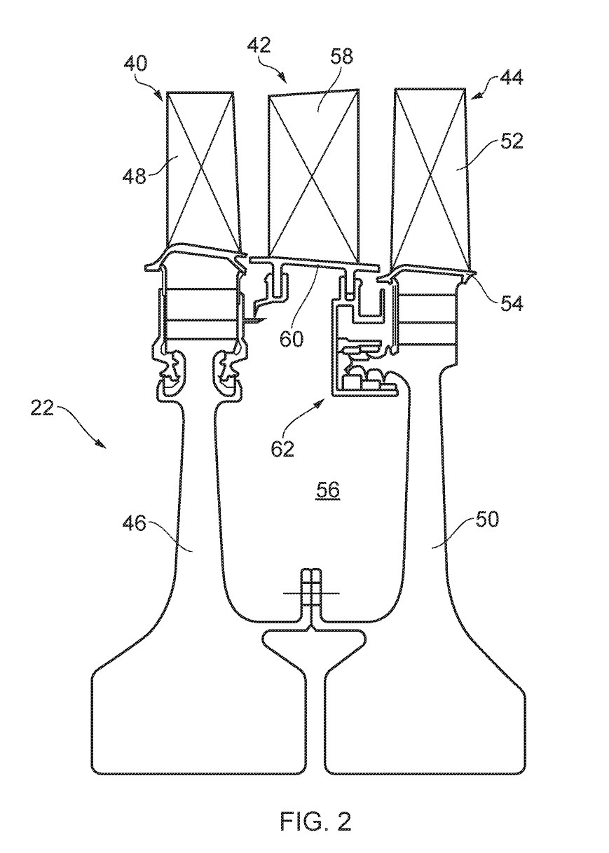

FIG. 2 is a schematic enlargement of part of a turbine section of a gas turbine engine including a sealing arrangement.

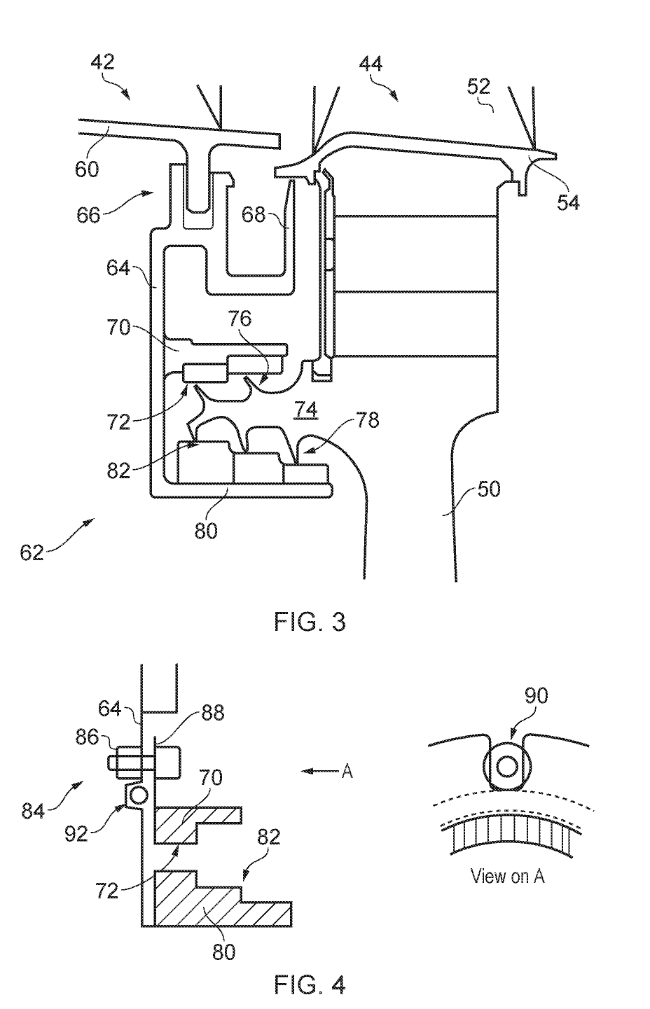

FIG. 3 is an enlargement of the sealing arrangement of FIG. 2.

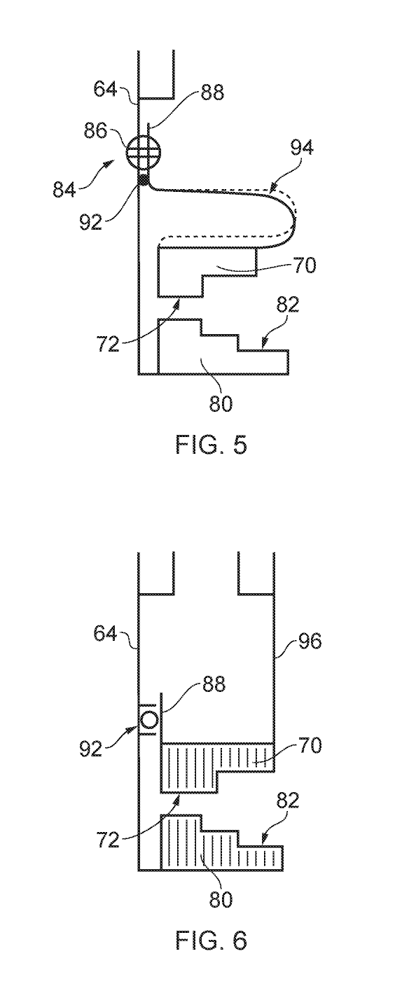

FIG. 4, FIG. 5 and FIG. 6 are enlargements of part of the sealing arrangement.

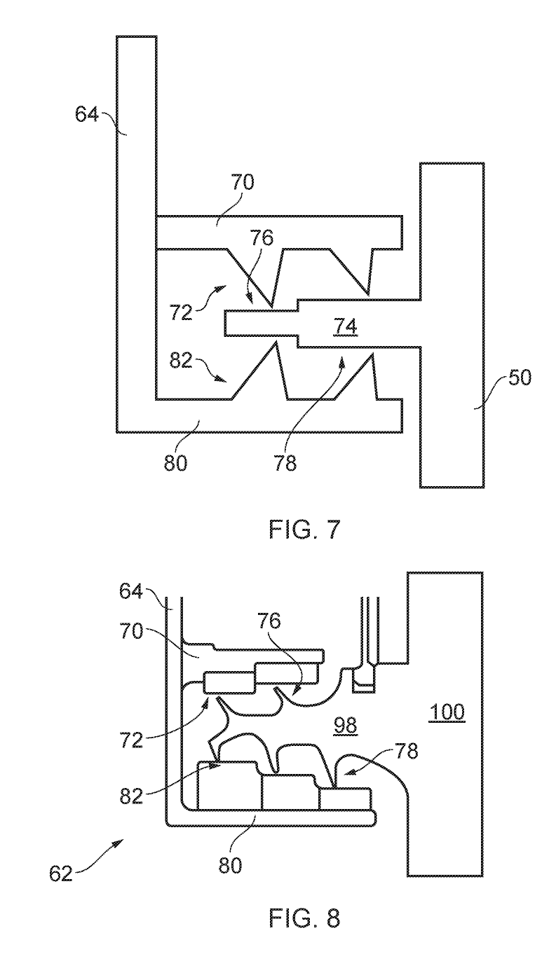

FIG. 7 is an enlargement of part of the sealing arrangement.

FIG. 8 is an enlargement of the sealing arrangement.

A gas turbine engine 10 is shown in FIG. 1 and has a rotational axis 9. The gas turbine engine 10 comprises an air intake 12 and a propulsive fan 14 that generates two airflows A and B. The gas turbine engine 10 comprises, in axial flow A, an intermediate pressure compressor 16, a high pressure compressor 18, a combustor 20, a high pressure turbine 22, an intermediate pressure turbine 24, a low pressure turbine 26 and an exhaust nozzle 28. A low pressure shaft 34 couples the low pressure turbine 26 to the fan 14; an intermediate pressure shaft 36 couples the intermediate pressure turbine 24 to the intermediate pressure compressor 16; a high pressure shaft 38 couples the high pressure turbine 22 to the high pressure compressor 18. A nacelle 30 surrounds the gas turbine engine 10 and defines, in axial flow B, a bypass duct 32.

In use, air is drawn into the air intake 12 and is accelerated by the fan 14. It is split into the two axial flows A, B. In a high bypass ratio gas turbine engine, the majority of the air is passed through the bypass duct 32 to be expelled to give propulsive thrust. The remainder of the air is passed into the core engine (axial flow A) where it is compressed and accelerated by the intermediate pressure compressor 16 and then the high pressure compressor 18. Fuel is injected into the combustor 20 and combusted with the air from the high pressure compressor 18. Hot combustion gases are expelled from the combustor 20. The gases are expanded and slowed through the high pressure turbine 22, intermediate pressure turbine 24 and finally through the low pressure turbine 26 before being expelled through the exhaust nozzle 28 to provide a small amount of the propulsive thrust.

FIG. 2 is a schematic enlargement of part of the high pressure turbine 22 of the gas turbine engine 10. The high pressure turbine 22 is illustrated as a two-stage turbine. Thus it comprises a first rotating stage 40, a static stage 42, and a second rotating stage 44. The first rotating stage 40 comprises a first stage rotor disc 46 to which is mounted an annular array of rotor blades 48. Similarly, the second rotating stage 44 comprises a second stage rotor disc 50 to which is mounted an annular array of rotor blades 52. Radially between the rotor blades 52 and the rotor disc 50 is a rim 54 which is in the form of a platform or skirt around the base of each rotor blade 52. The rim 54 is arranged to form a continuous annulus to divide the cavity 56 between the first stage disc 46 and second stage disc 50 from the gas path across the rotor blades 48, 52.

The static stage 42 comprises an annular array of static vanes 58, known as nozzle guide vanes 58, which each has a platform 60 at its radially inner end. The platforms 60 extend circumferentially to abut adjacent platforms 60 in order to form a continuous annulus to divide the cavity 56 between the first stage disc 46 and second stage disc 50 from the gas path across the vanes 58.

Between the platforms 60 of the static stage 42 and the rim 54 of the second rotating stage 44 is a sealing arrangement 62. The sealing arrangement 62 is described in more detail with respect to FIG. 3, which is an enlargement. The sealing arrangement 62 includes a static mounting structure 64 which is coupled to the platforms 60 of the static stage 42 in the region indicated by arrow 66. The coupling 66 may be any known arrangement to locate the static mounting structure 64 to the platforms 60. Extending from the static mounting structure 64 is a discourager seal 68. The discourager seal 68 includes a radially extending, annular portion which terminates with a fin or sharp edge. The discourager seal 68 is arranged to be closely adjacent, radially as drawn, to the axially forward portion of the second stage rim 54 in order to create an effective discourager between the discourager seal 68 and the rotating rim 54. The discourager prevents fluid flow across it, either of hot combustion gases from the gas path through the vanes 58 and blades 48, 52 into the cavity 56 or vice versa.

The sealing arrangement 62 includes a first seal land 70 which extends axially from the static mounting structure 64 towards the second stage turbine disc 50. The first seal land 70 is annular and includes a first seal surface 72 which faces radially inwardly. The first seal surface 72 may be comprised of one or more adjacent honeycomb rings. The first seal land 70 may have a stepped profile so that it is radially thicker close to the static mounting structure 64 than it is at the distal end, towards the second stage turbine disc 50. Where there is more than one adjacent honeycomb ring these may be the same radial thickness or may have different radial thickness to make the stepped profile more pronounced at the first seal surface 72.

The sealing arrangement 62 also includes a rotating sealing member 74 which extends axially from the disc 50 towards the static mounting structure 64. The rotating sealing member 74 may be integral with or mounted to the disc 50. The rotating sealing member 74 is annular. It includes a second seal surface 76 which faces radially outwardly. The second seal surface 76 may be integral with or mounted to the rotating sealing member 74. The second seal surface 76 may be formed as an axial array of annular fins or teeth. The fins may each have a different radial extent. The tips of the fins of the second seal surface 76 rotate close to the first seal surface 72 so as to form a labyrinth seal therebetween. Thus air from the cavity 56, which may be secondary air system cavity ventilation air, is metered through the labyrinth seal.

The rotating sealing member 74 also includes a third seal surface 78 which faces radially inwardly. The third seal surface 78 may be integral with or mounted to the rotating sealing member 74. The third seal surface 78 may be formed as an axial array of annular fins or teeth. The fins may each have a different radial extent.

The sealing arrangement 62 also includes a second seal land 80 which extends axially from the static mounting structure 64 towards the second stage turbine disc 50. The second seal land 80 is annular and includes a fourth seal surface 82 which faces radially outwardly. The fourth seal surface 82 may be comprised of one or more adjacent honeycomb rings. The second seal land 80 may have a stepped profile so that it is radially thicker close to the static mounting structure 64 than it is at the distal end, towards the second stage turbine disc 50. Where there is more than one adjacent honeycomb ring these may be the same radial thickness or may have different radial thickness to make the stepped profile more pronounced at the fourth seal surface 82.

The tips of the fins of the third seal surface 78 rotate close to the fourth seal surface 82 so as to form a labyrinth seal therebetween. Thus combustion gas or air from the cavity 56 is metered through the labyrinth seal. More precisely, air from the cavity 56, which may be secondary air system cavity ventilation air, is metered through the labyrinth seal formed between the fins of the third seal surface 78 and the fourth seal surface 82 and then is further metered through the labyrinth seal formed between the fins of the second seal surface 76 and the first seal surface 72. The metered fluid is then delivered to the discourager seal 68 which acts to permit a small flow past the discourager seal 68 into the gas path. The discourager seal 68 prevents fluid ingress from the combustion gas path.

The second seal land 80 is integrally formed with the static mounting structure 64 or is rigidly mounted thereto. Thus the fourth seal surface 82 is constrained to move radially in and out in concert with the static mounting structure 64, for example in response to pressure or mechanical loading, thermal or centrifugal growth and contraction of the static or rotating components of the sealing arrangement 62. Conversely, the first seal land 70 is not integrally formed with the static mounting structure 64. Instead the first seal land 70 may be compliantly mounted to the static mounting structure 64 so that it, and therefore the first seal surface 72, is able to move radially relative to the second seal land 80. Advantageously this compliance means that different radial movement of the static and rotating components of the sealing arrangement 62 can be accommodated because the first seal land 70 and first seal surface 72 can move radially by a different amount to the rotating sealing member 74 (and thus the second and third seal surfaces 76, 78) and the second seal land 80 and fourth seal surface 82. The first seal land 70 and first seal surface 72 can also move radially at a different rate to the rotating sealing member 74 (and thus the second and third seal surfaces 76, 78) and to the second seal land 80 and fourth seal surface 82. Thus different types and rates of radial growth and contraction experienced in different engine running conditions may be accommodated successfully.

The compliant mounting of the first seal land 70 may be achieved in a number of ways as will be discussed in relation to FIG. 4 to FIG. 6.

In FIG. 4 some of the static components of the sealing arrangement 62 are shown schematically. The second seal land 80 is integral with or mounted to the static mounting structure 64. The fourth seal surface 82 is stepped so that it is radially further out nearer to the static mounting structure 64 than it is in areas that are axially further from the static mounting structure 64. The first seal surface 72 is also stepped so that it is radially further in nearer to the static mounting structure 64 than it is in axially distal areas from the static mounting structure 64. The first seal land 70 is mounted to the static mounting structure 64 via a mounting 84. The mounting 84 includes an annular array of nuts and bolts 86 or other fixings which pass through apertures in the static mounting structure 64 and a flange 88 of the first seal land 70. The apertures in one of the static mounting structure 64 and flange 88 of the first seal land 70 are radially elongate, as shown in the view on A. Advantageously, providing elongate apertures 90 in the flange 88 of the first seal land 70 may minimise the leakage of air from the cavity 56 to the discourager seal 68 that bypasses the labyrinth seal. The elongate apertures 90 may be U-shaped so that they are open at one radial end, or may be oval so that they are closed at both ends. The elongate apertures 90 enable the first seal land 70 and the static mounting structure 64 to move radially by different amounts because the bolts 86 will rest at any position within the elongate apertures 90. Thus differential radial movement between the first seal surface 72 and the rotating second seal surface 76 is accommodated.

The mounting 84 may also include a seal 92, for example an O-ring, braid or convolute seal, between the static mounting structure 64 and the flange 88 of the first seal land 70. The seal 92 acts to prevent fluid passing between the components instead of through the second labyrinth seal between the first and second seal surfaces 72, 76.

Optionally the first seal land 70 and/or the first seal surface 72 may be comprised of a different material to the static mounting structure 64 to accentuate the differential radial movement. For example the material may have a different coefficient of thermal expansion a or a different thermal diffusivity. It may have a lower coefficient of thermal expansion a so that it expands by a smaller amount than other components of the sealing arrangement 62 and thus maintains a suitable clearance between the first and second seal surfaces 72, 76. It may have a lower thermal diffusivity so that it expands more quickly than other components of the sealing arrangement 62 and thus maintains a suitable clearance between the first and second seal surfaces 72, 76. This is particularly advantageous in rapid engine transients as the sealing arrangement 62 is able to react more quickly than known seals with a fixed radial spacing.

In FIG. 6 some of the static components of the sealing arrangement 62 are again shown schematically. The second seal land 80 is integral with or mounted to the static mounting structure 64. The fourth seal surface 82 is stepped so that it is radially further out nearer to the static mounting structure 64 than it is in areas that are axially further from the static mounting structure 64. The first seal surface 72 is also stepped so that it is radially further in nearer to the static mounting structure 64 than it is in axially distal areas from the static mounting structure 64. The first seal land 70 is mounted to the static mounting structure 64 via a mounting 84. The mounting 84 includes an annular array of nuts and bolts 86 or other fixings which pass through apertures in the static mounting structure 64 and the flange 88 of the first seal land 70. In contrast to FIG. 4, the apertures are not elongate so the flange 88 cannot move radially relative to the static mounting structure 64.

The mounting 84 may also include a seal 92, for example an O-ring, braid or convolute seal, between the static mounting structure 64 and the flange 88 of the first seal land 70. The seal 92 acts to prevent fluid passing between the components instead of through the second labyrinth seal between the first and second seal surfaces 72, 76.

The first seal land 70 comprises a spring 94 that extends in a convoluted path radially outwardly from the first seal land 70 to the flange 88 which is coupled to the static mounting structure 64 by the mounting 84. For example, the spring 94 may be a hairpin spring. The spring 94 may be formed from the same material as the first seal land 70 or a different material. The spring 94 is sufficiently compliant in the radial direction, by virtue of its convoluted shape, its thickness in the radial direction, and the material from which it is formed that it can flex radially. The radial flexing of the spring 94 thus accommodates differential radial movement of the first seal surface 70 relative to other components of the sealing arrangement 62.

In FIG. 6 some of the static components of the sealing arrangement 62 are again shown schematically. The second seal land 80 is integral with or mounted to the static mounting structure 64. The fourth seal surface 82 is stepped so that it is radially further out nearer to the static mounting structure 64 than it is in areas that are axially further from the static mounting structure 64. The first seal surface 72 is also stepped so that it is radially further in nearer to the static mounting structure 64 than it is in axially distal areas from the static mounting structure 64.

The first seal land 70 is not mounted to the static mounting structure 64. Instead the first seal land 70 is mounted to a separate mounting structure 96. The separate mounting structure 96 may be coupled to the platforms 60 of the static stage 42 at an axially spaced position to the static mounting structure 64, for example closer to the second rotating stage 44. The separate mounting structure 96 and/or the first seal land 70 and/or the first seal surface 72 may comprise a different material to other components of the sealing arrangement 62. In this manner differential radial movement of the first seal surface 70 relative to other components of the sealing arrangement 62 is accommodated.

A seal 92, for example an O-ring, braid or convolute seal, may be provided between the static mounting structure 64 and the flange 88 of the first seal land 70. The seal 92 acts to prevent fluid passing between the components instead of through the second labyrinth seal between the first and second seal surfaces 72, 76.

Alternatively, the first seal land 70 may be rigidly mounted to the static mounting structure 64 via mounting 84. However, the first seal land 70 is formed from a different material to the static mounting structure 64. The material may have a different coefficient of thermal expansion a or a different thermal diffusivity. For example it may have a lower coefficient of thermal expansion a so that it expands by a smaller amount than other components of the sealing arrangement 62 and thus maintains a suitable clearance between the first and second seal surfaces 72, 76. It may have a lower thermal diffusivity so that it expands more quickly than other components of the sealing arrangement 62 and thus maintains a suitable clearance between the first and second seal surfaces 72, 76. This is particularly advantageous in rapid engine transients as the sealing arrangement 62 is able to react more quickly than known seals with a fixed radial spacing.

Optionally there may be damping associated with the first seal land 70, howsoever mounted. Such damping may be arranged to retard the movement radially inwards of the first seal surface 72, for example in response to thermal contraction. The damping may be arranged to retard the movement for sufficient time that the inward radial movement of the rotating sealing member 74 and second seal land 80 occurs before, or no later than with, the radial movement of the first seal land 70 and not after it. Advantageously this minimises the possibility of rubbing between any of the components of the sealing arrangement 62. The damping may be active or passive; that is, it may be controlled or reactive.

In FIG. 7 the first seal land 70 is mounted to the static mounting structure 64 by any of the arrangements discussed above so that it is able to move radially by a different amount to the other components of the sealing arrangement 62. The second seal land 80 is integrally formed with or rigidly mounted to the static mounting structure 64 and thus moves radially in concert with the static mounting structure 64. The rotating sealing member 74 is integral with or mounted to the turbine disc 50 of the second rotating stage 44. In contrast to earlier figures, in FIG. 7 the first seal surface 72 comprises one or more axially spaced annular fins or teeth. The fins may have different radial extent and/or may be mounted to a stepped profile of the first seal land 70.

Similarly, the fourth seal surface 82 comprises one or more axially spaced annular fins or teeth. The fins may have different radial extent and/or may be mounted to a stepped profile of the second seal land 80. For example, for the first seal surface 72 and/or the further seal surface 82, the fins axially closer to the static mounting structure 64 may be longer in the radial direction than fins axially further from the static mounting structure 64.

The second seal surface 76 and third seal surface 78, which form the radially outer and radially inner surfaces of the rotating sealing member 74 respectively, each comprise annular surfaces. The second and third seal surfaces 76, 78 may comprise one or more honeycomb rings. The second and third seal surfaces 76, 78 and/or the rotating sealing member 74 may have a stepped profile so that it is radially thicker close to the disc 50 than at its distal extent, towards the static mounting structure 64.

Thus the labyrinth seal between the first and second seal surfaces 72, 76 has its fins and smooth surfaces reversed. Similarly, the labyrinth seal between the third and fourth seal surfaces 78, 82 also has its fins and smooth surfaces reversed. Advantageously it may be easier to manufacture fins on the static components. Advantageously providing the smooth surfaces on the rotating components reduces the weight of the disc 50, or that supported by the disc 50, and thus reduces the stress under which it functions.

The sealing arrangement 62 is also beneficial where the components between which sealing is required are not annular. In this case the first seal surface 72 faces in a first direction and the second seal surface 76 faces in a second direction which opposes the first direction. Preferably the first and second seal surfaces 72, 76 extend parallel to each other. Any stepped configuration of the first seal surface 72, or the first seal land 70 to which it is mounted, is preferably mirrored by the second seal surface 76. The steps may be arranged such that substantially flat portions of the first and second seal surfaces 72, 76 face in the first and second directions with joins between them being substantially parallel to the first and second directions. The second seal surface 76 and third seal surface 78 may be mounted to a third seal land 98 which replaces the rotating sealing member 74. The third seal land 98 extends from a component 100 towards the static mounting structure 64.

The third seal surface 78 faces in the first direction and the fourth seal surface 82 faces in the second direction. Preferably the third and fourth seal surfaces 78, 82 extend parallel to each other. Any stepped configuration of the fourth seal surface 82, or the second seal land 80 to which it is mounted, is preferably mirrored by the third seal surface 78. The steps may be arranged such that substantially flat portions of the third and fourth seal surfaces 78, 82 face in the first and second directions with joins between them being substantially parallel to the first and second directions.

The first seal land 70 is mounted to the static mounting structure 64 by a compliant mounting as previously described. Thus the differential movement between the seal surfaces 72, 76, 78, 82 that is accommodated is substantially parallel to the first and second directions, which themselves are parallel. The differential movement may be substantially perpendicular to the seal surfaces 72, 76, 78, 82.

Stepped configurations of the seal surfaces 72, 76, 78, 82 and/or seal lands 70, 80, 98 have been proposed. Alternatively parts of the seal surfaces 72, 76, 78, 82 and/or seal lands 70, 80, 98 may be angled relative to the first and second directions.

The sealing arrangement 62 may be arranged so that the first and second seal lands 70, 80, and thus the first and fourth seal surfaces 72, 82, rotate. Thus the static mounting structure 64 is replaced by a rotating mounting structure. This may be in addition to the rotating sealing member 74, second and third seal surfaces 76, 78 rotating. Alternatively the rotating sealing member 74 may be replaced by a static sealing member so that the second and third seal surfaces 76, 78 are static. Either of the first and second seal surfaces 72, 76 may comprise fins or teeth. Preferably the other of the first and second seal surfaces 72, 76 has smooth annular portions aligned with the fins. Either of the third and fourth seal surfaces 78, 82 may comprise fins or teeth. Preferably the other of the third and fourth seal surfaces 78, 82 has smooth annular portions aligned with the fins.

The sealing arrangement 62 may be used as a turbine secondary air system seal arrangement. The turbine secondary air system seal arrangement includes a first seal land 70 with a first seal surface 72 facing radially inwards, and a second seal land 80 with a second seal surface 76 facing radially outwards. The arrangement also includes first labyrinth seal teeth, forming a second seal surface 76, directed radially outwards to seal against the first seal surface 72 of the first seal land 70. The arrangement also includes second labyrinth seal teeth, forming a third seal surface 78, directed radially inwards to seal against the fourth seal surface 82 of the second seal land 80. The first seal land 70 is configured to move radially relative to the second seal land 80. Alternatively the first seal teeth 76 are configured to move radially relative to the second seal teeth 78. The radial movement accommodates differential movement of the lands 70, 80 and teeth 76, 78 during use of the turbine rim seal arrangement. The turbine rim seal arrangement may be part of a gas turbine engine 10.

An advantage of the sealing arrangement 62 is that the clearance between sealing surfaces 72, 76, 78, 82 is smaller than in known arrangements. Rubbing between components may also be reduced or eliminated. Thus fuel consumption in a gas turbine engine 10 using the sealing arrangement 62 is improved. Advantageously the differential displacement of the components of the sealing arrangement 62 may be transient, in order to accommodate the differential movement during transient engine conditions, particularly rapid transient conditions. Advantageously this may also improve management of bearing loads. During steady movements of the components the first seal land 70 may move approximately in concert with the second seal land 80 and static mounting structure 64.

The sealing arrangement 62 provides improved control over rim sealing flow and improved pressure control for the cavity 56. The former improves fuel consumption for the engine. The latter improves management of bearing loads. These benefits are greater than any potential extra leakage caused by the additional joint between the flange 88 of the first seal land 70 and the static mounting structure 64. In any case, such extra leakage may be minimised by use of the seal 92. The sealing arrangement 62 may be used in place of single-sided labyrinth seals in some applications.

The sealing arrangement 62 has been described for a gas turbine engine 10. Such a gas turbine engine 10 may be used to power an aircraft or be used in marine or industrial power applications. The sealing arrangement 62 finds utility in rotating-rotating and rotating-static interfaces to be sealed. The sealing arrangement 62 is particularly beneficial in turbine stages 22, 24, 26 of a gas turbine engine 10. However, it also finds utility in other rotating stages such as the compressors 16, 18 and fan 14, and to seal bearing housings. It may also find utility in intershaft seals; that is, seals between relatively rotating shafts such as between the low pressure and intermediate pressure shafts 34, 36 or between the intermediate pressure and high pressure shafts 36, 38. The sealing arrangement 62 is also beneficial in sealing between non-rotating components which nevertheless experience relative movement between them.

The sealing arrangement 62 may alternatively be used in a steam turbine.

1. A seal arrangement (62) comprising:
a first seal surface (72) facing a first direction;
a second seal surface (76) facing a second direction, the second direction opposed to the first direction; the first and second seal surfaces (72, 76) configured to form a seal together;
a third seal surface (78) facing the first direction;
a fourth seal surface (82) facing the second direction; the third and fourth seal surfaces (78, 82) configured to form a seal together;
wherein the first and fourth seal surfaces (72, 82) are configured to move relative to each other to accommodate differential movement of the seal surfaces during use of the seal arrangement (62).

2. A seal arrangement (62) as claimed in claim 1 wherein the seal arrangement (62) is a labyrinth seal arrangement (62).

3. A seal arrangement (62) as claimed in claim 2 wherein the first and fourth seal surfaces (72, 82) comprise seal lands; and wherein the second and third seal surfaces (76, 78) comprise fins or teeth.

4. A seal arrangement (62) as claimed in claim 2 wherein the first and fourth seal surfaces (72, 82) comprise fins or teeth; and wherein the second and third seal surfaces (76, 78) comprise seal lands.

5. A seal arrangement (62) as claimed in claim 1 wherein the relative movement is substantially perpendicular to the seal surfaces (72, 76, 78, 82).

6. A seal arrangement (62) as claimed in claim 1 wherein the second and third seal surfaces (76, 78) are supported by a common mount (74).

7. A seal arrangement (62) as claimed in claim 1 wherein any one or more of the seal surfaces (72, 76, 78, 82) comprises a stepped or angled profile relative to the first and second directions.

8. A seal arrangement (62) as claimed in claim 1 wherein the first seal surface (72) is mounted to the fourth seal surface (82).

9. A seal arrangement (62) as claimed in claim 8 wherein the first seal surface (72) is mounted to the fourth seal surface (82) by a pin in a slot or by a sprung coupling (94).

10. A seal arrangement (62) as claimed in claim 1 wherein the first and fourth seal surfaces (72, 82) are mounted to different components.

11. A seal arrangement (62) as claimed in claim 1 wherein the first seal surface (72) comprises a different material to the fourth seal surface (82).

12. A seal arrangement (62) as claimed in claim 1 wherein the arrangement is annular and the relative movement is radial.

13. A seal arrangement (62) as claimed in claim 12 wherein the first and fourth seal surfaces (72, 82) are static; and wherein the second and third seal surfaces (76, 78) rotate.

14. A seal arrangement (62) as claimed in claim 12 wherein the first and fourth seal surfaces (72, 82) rotate; and wherein the second and third seal surfaces (76, 78) are static.

15. A rotational arrangement comprising a rotating stage (40, 44), a static stage (42) and a seal arrangement (62) as claimed in claim 1, the seal arrangement (62) arranged between the rotating stage (40, 44) and the static stage (42).

16. A seal arrangement (62) as claimed in claim 12 wherein the first and fourth seal surfaces (72, 82) rotate; and wherein the second and third seal surfaces (76, 78) rotate.

17. A gas turbine engine (10) comprising a seal arrangement (62) as claimed in claim 1.

18. A gas turbine engine (10) comprising a rotational arrangement as claimed in claim 15.

19. A turbine secondary air system seal arrangement (62) comprising:
a first seal land (70) facing radially inwardly;
a second seal land (80) facing radially outwardly;
first labyrinth seal teeth (76) directed radially outwardly to seal against the first seal land (70);
second labyrinth seal teeth (78) directed radially inwardly to seal against the second seal land (80);
wherein
i) the first seal land (70) is configured to move radially relative to the second seal land (80) or
ii) the first seal teeth (76) are configured to move radially relatively to the second seal teeth (78)
to accommodate differential movement of the lands (70, 80) and teeth (76, 78) during use of the seal arrangement (62).

20. A gas turbine engine (10) comprising a turbine secondary air system seal arrangement (62) as claimed in claim 19.
